(19) United States
(12) Patent Application Publication
(10) Pub. No.: US 2021/0042645 A1
(43) Pub. Date: Feb. 11, 2021

(54) Tensor Exchange for Federated Cloud Learning

(71) Applicant: doc.ai, Inc., Palo Alto, CA (US)

(72) Inventors: Srivatsa Akshay SHARMA, Palo Alto, CA (US); Frederick Franklin KAUTZ, IV, Fremont, CA (US); Marina TITOVA, Menlo Park, CA (US); Walter Adolf DE BROUWER, Los Altos, CA (US); Gabriel Gabra ZACCAK, Cambridge, MA (US); Andrés RODRÍGUEZ ESMERAL, Vancouver (CA)

(73) Assignee: doc.ai, Inc., Palo Alto, CA (US)

(21) Appl. No.: 16/987,279

(22) Filed: Aug. 6, 2020

Related U.S. Application Data
(60) Provisional application No. 62/883,639, filed on Aug. 6, 2019.

(51) Int. Cl. G06N 5/04; G06F 16/23; G06F 16/21; G06N 20/20

(52) U.S. Cl. CPC G06N 5/04; G06N 20/20; G06F 16/212; G06F 16/2379

(57) ABSTRACT

A federated training system comprises a plurality of models, a plurality of training datasets, and a runtime intermediary. Models in the plurality of models have model coefficients responsive to training. Training datasets in the plurality of training datasets are annotated with ground truth labels to train the models. The training datasets are accompanied with training provisioning parameters and privacy parameters. The runtime intermediary is interposed between the models and the training datasets, and configured to receive requests for training the models on the training datasets, the requests accompanied with training acquisition parameters, to respond to the requests by matching the models with the training datasets based on evaluating the training acquisition parameters against the training provisioning parameters, to train the models on the matched training datasets in accordance with the privacy parameters to generate gradients with respect to the model coefficients.

### PRIORITY DATA

This application claims the benefit of U.S. Patent Application No. 62/883,639, entitled “FEDERATED CLOUD LEARNING SYSTEM AND METHOD”, filed Aug. 6, 2019 (Attorney Docket No. DCAI 1014-1). The provisional application is incorporated by reference for all purposes.

### INCORPORATIONS

The following are incorporated by reference for all purposes as if fully set forth herein:
Google, Communication-Efficient Learning of Deep Networks from Decentralized Data, February 2017;
Google, Towards Federated Learning at Scale: System Design, February 2019;
WeBank, Federated Learning Whitepaper v1.0, September 2019;
Ian Goodfellow, H. Brendan McMahan, et. al., Deep Learning with Differential Privacy, October 2016;
Om Thakkar Galen Andrew H. Brendan McMahan, Differentially Private Learning with Adaptive Clipping, May 2019;
Google, Practical Secure Aggregation for Federated Learning on User-Held Data, November 2016;
Google, A General Approach to Adding Differential Privacy to Iterative Training Procedures, March 2019;
Cynthia Dwork, The Algorithmic Foundations of Differential Privacy, 2014;
U.S. Patent Application No. 62/883,070, entitled “ACCELERATED PROCESSING OF GENOMIC DATA AND STREAMLINED VISUALIZATION OF GENOMIC INSIGHTS”, filed Aug. 5, 2019 (Attorney Docket No. DCAI 1000-1);
U.S. Patent Application No. 62/734,840, entitled “HASH-BASED EFFICIENT COMPARISON OF SEQUENCING RESULTS”, filed Sep. 21, 2018 (Attorney Docket No. DCAI 1001-1);
U.S. Patent Application No. 62/734,872, entitled “BIN-SPECIFIC AND HASH-BASED EFFICIENT COMPARISON OF SEQUENCING RESULTS”, filed Sep. 21, 2018 (Attorney Docket No. DCAI 1001-2);
U.S. Patent Application No. 62/734,895, entitled “ORDINAL POSITION-SPECIFIC AND HASH-BASED EFFICIENT COMPARISON OF SEQUENCING RESULTS”, filed Sep. 21, 2018 (Attorney Docket No. DCAI 1001-3);
U.S. patent application Ser. No. 16/575,276, entitled “HASH-BASED EFFICIENT COMPARISON OF SEQUENCING RESULTS”, filed Sep. 18, 2019 (Attorney Docket No. DCAI 1001-4);
U.S. patent application Ser. No. 16/575,277, entitled “BIN-SPECIFIC AND HASH-BASED EFFICIENT COMPARISON OF SEQUENCING RESULTS”, filed Sep. 18, 2019 (Attorney Docket No. DCAI 1001-5);
U.S. patent application Ser. No. 16/575,278, entitled “ORDINAL POSITION-SPECIFIC AND HASH-BASED EFFICIENT COMPARISON OF SEQUENCING RESULTS”, filed Sep. 18, 2019 (Attorney Docket No. DCAI 1001-6);
U.S. Patent Application No. 62/942,644, entitled “SYSTEMS AND METHODS OF TRAINING PROCESSING ENGINES”, filed Dec. 2, 2019 (Attorney Docket No. DCAI 1002-1);
U.S. Patent Application No. 62/964,586, entitled “SYSTEM AND METHOD WITH FEDERATED LEARNING MODEL FOR MEDICAL RESEARCH APPLICATIONS”, filed Jan. 22, 2020 (Attorney Docket No. DCAI 1003-1);
U.S. Patent Application No. 62/975,177, entitled “ARTIFICIAL INTELLIGENCE-BASED DRUG ADHERENCE MANAGEMENT AND PHARMACOVIGILANCE”, filed Feb. 11, 2020 (Attorney Docket No. DCAI 1005-1);
U.S. Patent Application No. 62/481,691, entitled “IMAGE-BASED SYSTEM AND METHOD FOR PREDICTING PHYSIOLOGICAL PARAMETERS”, filed Apr. 5, 2017 (Attorney Docket No. DCAI 1006-1);
U.S. patent application Ser. No. 15/946,629, entitled “IMAGE-BASED SYSTEM AND METHOD FOR PREDICTING PHYSIOLOGICAL PARAMETERS”, filed Apr. 5, 2018 (Attorney Docket No. DCAI 1006-2);
U.S. Patent Application No. 62/810,549, entitled “SYSTEM AND METHOD FOR REMOTE MEDICAL INFORMATION EXCHANGE”, filed Feb. 26, 2019 (Attorney Docket No. DCAI 1007-1);
U.S. patent application Ser. No. 16/802,485, entitled “SYSTEM AND METHOD FOR REMOTE MEDICAL INFORMATION EXCHANGE”, filed Feb. 26, 2020 (Attorney Docket No. DCAI 1007-2);
U.S. Patent Application No. 62/816,880, entitled “SYSTEM AND METHOD WITH FEDERATED LEARNING MODEL FOR MEDICAL RESEARCH APPLICATIONS”, filed Mar. 11, 2019 (Attorney Docket No. DCAI 1008-1);
U.S. patent application Ser. No. 16/816,153, entitled “SYSTEM AND METHOD WITH FEDERATED LEARNING MODEL FOR MEDICAL RESEARCH APPLICATIONS”, filed Mar. 11, 2020 (Attorney Docket No. DCAI 1008-2);
U.S. Patent Application No.: PCT/US2020/22200, entitled “SYSTEM AND METHOD WITH FEDERATED LEARNING MODEL FOR MEDICAL RESEARCH APPLICATIONS”, filed Mar. 11, 2020 (Attorney Docket No. DCAI 1008-3);
U.S. Patent Application No. 62/839,151, entitled “SYSTEM AND METHOD FOR INFORMATION EXCHANGE WITH A MIRROR”, filed Apr. 26, 2019 (Attorney Docket No. DCAI 1009-1);
U.S. patent application Ser. No. 16/858,535, entitled “SYSTEM AND METHOD FOR INFORMATION EXCHANGE WITH A MIRROR”, filed Apr. 24, 2020 (Attorney Docket No. DCAI 1009-2);
U.S. Patent Application No. 63/013,536, entitled “ARTIFICIAL INTELLIGENCE-BASED GENERATION OF ANTHROPOMORPHIC SIGNATURES AND USE THEREOF”, filed Apr. 21, 2020 (Attorney Docket No. DCAI 1010-1); and
U.S. Patent Application No. 63/023,854, entitled “PRIVACY INTERFACE FOR DATA LOSS PREVENTION VIA ARTIFICIAL INTELLIGENCE MODELS”, filed May 12, 2020 (Attorney Docket No. DCAI 1011-1).

### FIELD OF THE TECHNOLOGY DISCLOSED

The disclosure relates generally to a federated cloud learning system and method that has a privacy-preserving machine learning protocol, whereby inferences on data can be transacted or exchanged without ever revealing the data.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

Federated Cloud Learning is a distributed machine learning approach which enables model training on a large corpus of secure data that resides in one or more clouds to which the party training the model does not have access to. By applying the right balance of privacy and security techniques it is possible to keep the data secure on the cloud, with minimal leakage of the data itself in the trained model.

The world is becoming increasingly data-driven. Machine learning is driving more automation into businesses, allowing the delivery of new levels of efficiency and products that are tailored to business outcomes and individual customer preferences. This results in dramatically accelerated volumes of data generation.

The global datasphere, defined by International Data Corporation (“DC”) as the summation of all the world's data, whether it is created, captured, or replicated, is predicted to grow from 33 Zettabytes (ZB) in 2018 to 175 ZB by 2025.

Reliance on cloud services for both enterprises and consumers continues to increase. Companies continue to pursue the cloud for data processing needs, and cloud data centers are quickly becoming the new enterprise data repositories. IDC expects that by 2021, there will be more data stored in the cloud than in traditional data centers.

For example, accounts and transactional data is one of the most valuable assets for a large bank. The lending and other product data generated over millions of users, both individual and corporate, over decades, and well-curated, is a rich knowledge graph of information that is valuable for many players in the finance industry. Having access to this data by a private equity fund or a hedge fund will help build or enhance investment models.

Yet today, significant amounts of such data remain predominantly inaccessible to derive valuable insights via machine learning due to privacy and security concerns, as well as regulatory limitations, for example in accordance with General Data Protection Regulation (EU GDPR) and similar regulations in other jurisdictions. There are also concerns about the difficulty to move big data around, de-identifying the data, structuring the process as continuous data-sale vs one-time sale, as well as reputational risks. Such concerns exist widely across any industry and are only becoming more pronounced with the advancement of Big Data.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings, in which.

FIG. 1 illustrates one implementation of the disclosed federal cloud learning protocol.

FIG. 2 shows an example tensor exchange (TXE) market diagram.

FIGS. 3 and 4 show implementations of the disclosed federal cloud learning protocol in a multi-party setup.

FIG. 5 shows one implementation of the disclosed Federated Cloud Learning Runtime Environment.

FIG. 6 illustrates example workflows of the disclosed Federated Cloud Learning Runtime Environment.

FIG. 7 shows different modules of the disclosed Federated Cloud Learning Runtime Environment.

FIG. 8 shows one example of the technology disclosed using differential privacy to provide plausible deniability in the disclosed Federated Cloud Learning Runtime Environment.

FIG. 9 shows one example of applying differential privacy in the disclosed Federated Cloud Learning Runtime Environment.

FIG. 10 is a flowchart of a method implementation of the technology disclosed.

FIGS. 11 and 12 show implementations of the disclosed federal cloud learning protocol in a multi-party setup, mediated by a trusted third-party server.

FIG. 13 is a computer system that can be used to implement the technology disclosed herein.

### DETAILED DESCRIPTION

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

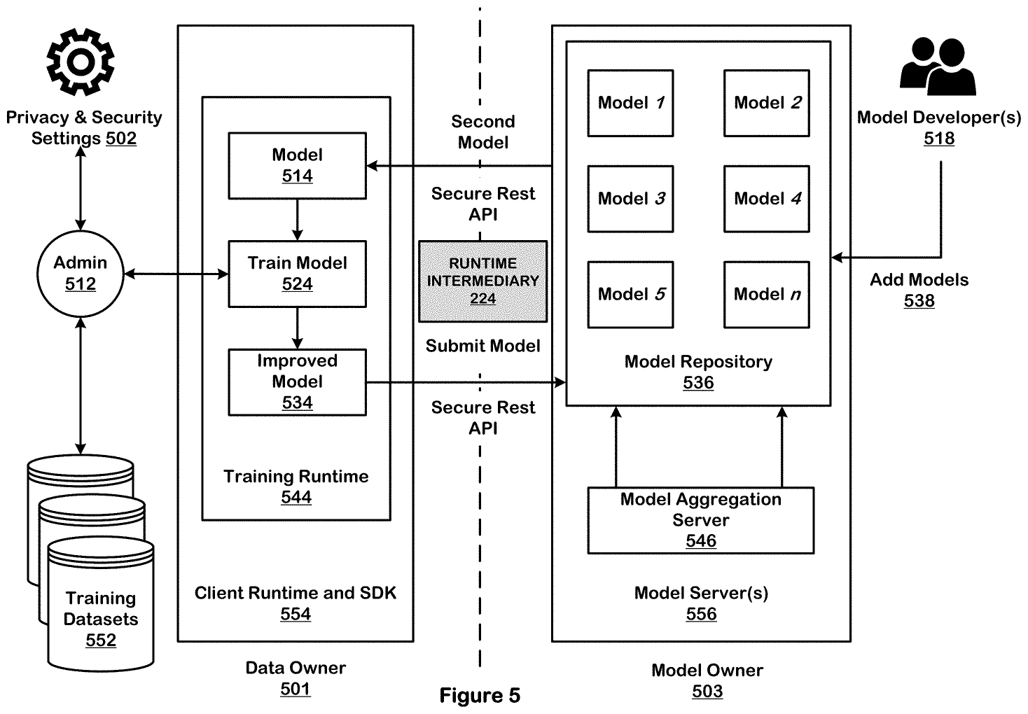

A federated training system is described. The system comprises a plurality of models (e.g., models 1-n in model repository 536 of FIG. 5), a plurality of training datasets (e.g., training datasets 552), and a runtime intermediary 224. Models in the plurality of models have model coefficients (or weights) responsive to training. The models are accompanied with model metadata, including model hyperparameters (e.g., learning rate). Training datasets in the plurality of training datasets are annotated with ground truth labels to train the models. The training datasets are accompanied with dataset metadata, including training provisioning parameters (training costs or asks) and privacy parameters. The runtime intermediary 224 is interposed between the models and the training datasets, and configured to receive requests for training the models on the training datasets, the requests accompanied with request metadata, including training acquisition parameters (training offers or bids), to respond to the requests by matching the models with the training datasets based on evaluating the training acquisition parameters against the training provisioning parameters, to train the models on the matched training datasets in accordance with the model hyperparameters and the privacy parameters to generate gradients with respect to the model coefficients (or weights), the gradients generated based on computing error between predictions by the models on the training datasets and the ground truth labels, and to make the gradients available for updating the model coefficients and generating the trained models.

In one implementation, the training datasets are domain-specific (e.g., health, financial, computing, hospitality). In one implementation, the training datasets include raw data, processed data, derived data, and market data. In one implementation, the training datasets are modifiable in real-time, and the training provisioning parameters are responsive to the real-time modifications.

In one implementation, the dataset metadata identifies dataset schema, dataset usage examples, data set purposes, and dataset ratings. In one implementation, the models are provided by model servers, and the training datasets are provided by dataset servers. The runtime intermediary creates a secure tunnel to receive the models, and the secure tunnel prevents the model servers from accessing the training datasets.

In one implementation, the runtime intermediary returns the trained models to the model servers. In one implementation, the runtime intermediary trains the models on the matched training datasets using a plurality of edge devices, edge devices in the plurality of edge devices including user endpoints and servers, and configured to receive the matched training datasets, the model coefficients, the model hyperparameters, and the privacy parameters to train the models on the matched training datasets in accordance with the model hyperparameters and the privacy parameters to generate a plurality of the gradients with respect to the model coefficients.

In one implementation, the runtime intermediary, upon matching of the models with the training datasets, is further configured to generate a data instrument that specifies transaction updates, including overtime changes to the training acquisition parameters and the training provisioning parameters, memorialization of the training acquisition parameters and the training provisioning parameters that brought about the matching, ownership details of the model servers and the dataset servers, transactional details of the matching, data schema of the training datasets, including input features and precision and recall measures, terms and conditions of the training, including lifetime of the matching, training duration, and privacy specifications, and ratings, including feedback based on prior instances of the matching and third-party opinion on the matching.

In one implementation, the model servers are configured to receive and aggregate the plurality of the gradients, and to update the model coefficients based on the aggregated plurality of the gradients to generate the trained models. In one implementation, trusted third-party servers are configured to receive and aggregate the plurality of the gradients, to update the model coefficients based on the aggregated plurality of the gradients to generate the trained models, and to send the trained models to the model servers. In one implementation, the trusted third-party servers apply a plurality of privacy enhancers on the gradients prior to making the gradients available to the model servers. In one implementation, the model servers are configured to test the trained models on validation sets, and to request the runtime intermediary to further train the trained models based on results of the test.

In one implementation, the request for further training specifies a training duration, and is accompanied with updated model hyperparameters. In one implementation, the runtime intermediary provides a dashboard for configuration of the privacy parameters. In one implementation, the runtime intermediary applies a plurality of privacy enhancers on the gradients prior to making the gradients available to the model servers. In some implementations, privacy enhancers in the plurality of privacy enhancers include differential privacy addition, multi-party computation, and homomorphic encryption.

A computer-implemented method of federated training is described. The method includes receiving requests for training models in a plurality of models on training datasets in a plurality of training datasets, the requests accompanied with request metadata, including training acquisition parameters, the models having model coefficients responsive to training, the models accompanied with model metadata, including model hyperparameters, and the training datasets annotated with ground truth labels to train the models, the training datasets accompanied with dataset metadata, including training provisioning parameters and privacy parameters; responding to the requests by matching the models with the training datasets based on evaluating the training acquisition parameters against the training provisioning parameters; training the models on the matched training datasets in accordance with the model hyperparameters and the privacy parameters to generate gradients with respect to the model coefficients, the gradients generated based on computing error between predictions by the models on the training datasets and the ground truth labels; and making the gradients available for updating the model coefficients and generating the trained models.

One or more implementations of the technology disclosed, or elements thereof can be implemented in the form of a computer product including a non-transitory computer readable storage medium with computer usable program code for performing the method steps indicated. Furthermore, one or more implementations of the technology disclosed, or elements thereof can be implemented in the form of an apparatus including a memory and at least one processor that is coupled to the memory and operative to perform exemplary method steps. Yet further, in another aspect, one or more implementations of the technology disclosed or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

Federated Learning has redefined how machine learning is used in any industry where data cannot easily be transferred away from its source. Federated Learning allows for the training of machine learning models by bringing the models and computation directly to the data, rather than moving the data to a central location for training.

In a typical machine learning architecture, all data is transferred to a central location for training. With Federated Learning, only model parameters are transferred to and from the data location in the cloud. With that, Federated Learning allows each party to keep their data private.

Initial Federated Learning implementations were focused on structures with a large number of edge devices contributing to the training of a combined model (for example, Google using Federated Learning for mobile keyboard prediction).

The disclosure is particularly applicable to a federated cloud learning system and method and it is in this context that the disclosure will be described. It will be appreciated, however, that the system and method in accordance with the invention has greater utility. Furthermore, the Federated Cloud Learning system and method are applicable for a broad range of industries (as described below in more detail) including, for example: 1) Pharmaceutical companies: train models on healthcare insurers and hospitals for clinical trials, drug adherence, rare diseases diagnostics; 2) Health insurers: monetize claims data; 3) Investment management: train and back test models on various currently unavailable for purchase datasets; 4) Banking: monetize lending and other banking data; 5) Governments: allow pharmaceutical and other companies to train models on its citizens data, with predictions from those models benefitting various aspects of citizens' life; 6) Large enterprises: Build privacy safe analytics, analyses and models, taking advantage of more data across enterprise, while preserving privacy of respective departments; and 7) Companies in possession of large data assets: monetize their data without losing control of it.

Federated Cloud Learning focuses on a smaller number of parties (as little as two parties, one as data owner, and the other as model owner), typically with one of the parties owning large amounts of data located in its respective cloud or data center, that the other party is interested to train its models on.

With Federated Cloud Learning, unlike traditional machine learning methodologies, data owner (data owner) no longer has to sell the data to model owner and instead is only leasing the data temporarily on its own cloud for the purposes of training model owner (model owner)'s models. By using aggregated updates to train algorithms instead of raw data, Federated Cloud Learning empowers companies from sectors where data cannot be transferred to third parties for confidentiality reasons with data network effects.

Both parties benefit significantly from such setup because: data owner (data owner) generate revenue by training model owner's models on their data without revealing any of the data; and model owner (model owner): create a robust, comprehensive and specific model using own data, as well as data owner's data, but without ever having received the data itself.

To summarize, Federated Cloud Learning is a system in which:
Multiple parties (as little as two) build a machine learning model under a data federation system, gaining benefit from the data of all parties in the setup. The model can either be shared between the parties, or not, depending on the agreement between the parties.
Each respective party's data remains located in its original cloud location, ensuring data security and privacy, and compliance with regulations.
The resulting model has the same, or nearly the same performance as the model that would have been built by combining all the data together in one location.

### Data Instruments Marketplace—TensorXchange

As outlined above, Federated Cloud Learning is a system in which multiple parties (as little as two) build a machine learning model under a data federation system, gaining benefit from the data of all parties in the setup. The model can either be shared between the parties, or not, depending on the agreement between the parties.

To take this one step further, we have developed the concept of a marketplace for data instruments, where inferences on the data can be transacted among multiple parties, with those transactions priced automatically based on bid and offer quotes between the parties, just as securities are traded on a regulated exchange—TensorXchange (tensor exchange) (“TXE”), also called a runtime intermediary 224.

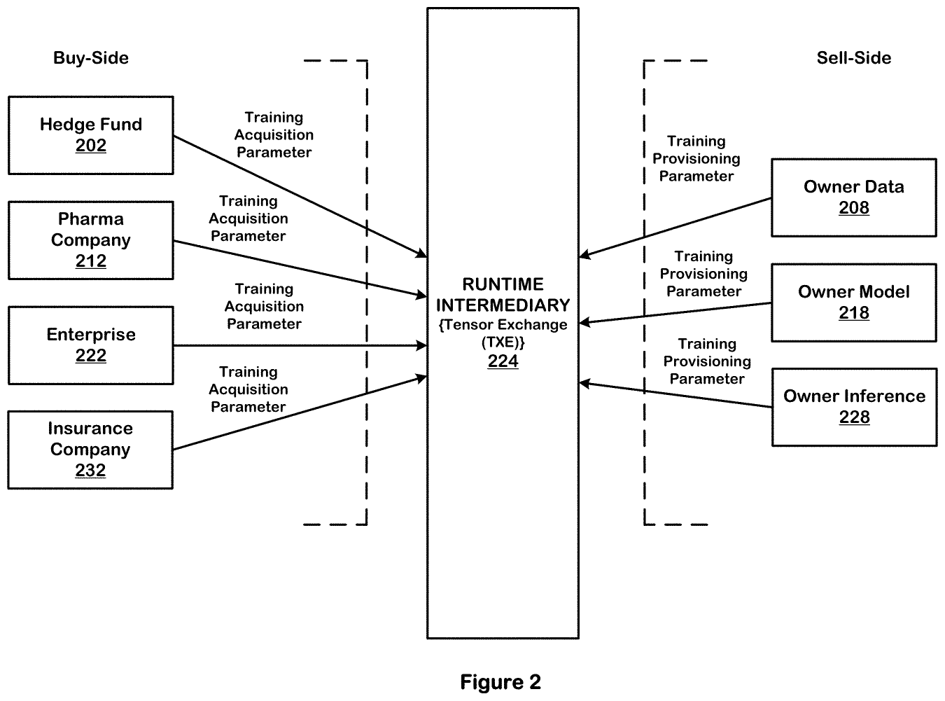

FIG. 2 shows an example tensor exchange (TXE) market diagram. The tensor exchange (TXE) market diagram includes different types of model owners on the left, buy-side, including a hedge fund 202, a pharma company 212, an enterprise 222, and an insurance company 232, each of which proposing training acquisition parameters. On the right, the sell-side contains data owner data 208, data owner model 218, and data owner inference 228.

### Data Instruments

The typical understanding of the data is just the raw data. We extend the meaning of data into data instruments by introducing the following entities:
Raw Data—“as is” data from data owners. Example of this could be data collected by apps on spending habits on users.
Processed Data—data that is normalized and cleaned up for sale from data owners. For example, this could be cleaned-up claims data from insurance companies.
By-products of Data (also can be introduced as Derivatives on Data):
   Inferred Data: data that is compiled by applying algorithms or processing on the data. This could be data in tensor form or just standard compiled analytics. Example of this could be part of some models or just analytics or statistics needed on top of the data.
   Machine Learning Models: complete tensors that provide one or more functionalities that a model owner might be interested in. Example of this could be a model on Diabetes sold by Hospital to a Pharma company that is interested in building a new drug.
   Market Data: Data that is generated by TXE as part of transactions and valuable for subsequent market making. Examples include last sale prices, volumes, quotes, depth of book, index, and more.

### Characteristics of Data Instruments

The above mentioned Data Instruments have certain characteristics that need to be considered when exchanged in a marketplace:
Associated metadata
Metadata describes the schema of the data, examples of usage, purposes, and more. The model owner can audit and buy the right data by sampling the metadata. TXE provides tools for model owners to scrutinize the data instrument before buying. Some fields of the data include:
   Transaction updates
   Valuation
   Customer details
   Counterparty details (after sale)
   Account details
   Data schema
   Terms and conditions
   Ratings
Realtime vs One-time

The data instrument could be continuously updated as the data owner's data could be a constantly growing data set. Alternatively, the data could also be a one-time piece of information. TXE supports both configurations and there are different financial configurations to support them.
Demand for the same information from multiple model owners

The critical aspect of TXE is that it is intended as a marketplace for model owners and data owners. The same piece of data instrument a data owner offers could interest multiple model owners. TXE facilitates the marketplace behavior (buy/sell/bid etc.) to build a close to efficient market. The model owners and data owners do not have to deal with too many parties.

### Primary Functions of TXE Include (but not Limited to):

Facilitate regulatory requirements on data instruments, for example, perform audits.
Listing—work with data owners to audit and list data instruments.
Market Data Instruments—provide services for model owners to understand each data instrument to buy.
Rating—TXE uses algorithmic as well as manual techniques to rate data instruments so model owners have better understanding of the data they are intending to transact in.
Venue for broker-dealers to work with data owners and model owners for listing and trading data instruments.
Matching Engine—using algorithms to facilitate the matching of model owners and data owners.
Clearing and Settlement—updating the accounts of the trading parties and arranging for the transfer of funds and data instruments, followed by actual exchange of funds and data instruments between the parties of a trade.
Owner of data instruments—optionally for some data owners TXE can act as an intermediary holding the data instrument facilitating speedy exchanges. TXE can host large datasets and can effectively use secure caching techniques to provide rapid access to data instruments if needed.

### Data Flow and Technical Architecture

There are four key pieces when describing the data flow and the technical architecture of the Federated Cloud Learning and TXE.
1. Federated Cloud Learning Protocol
2. Federated Cloud Learning Runtime Environment
3. Workflows for model owner and data owner
4. Federated Cloud Learning Modules

### Federated Cloud Learning Protocol

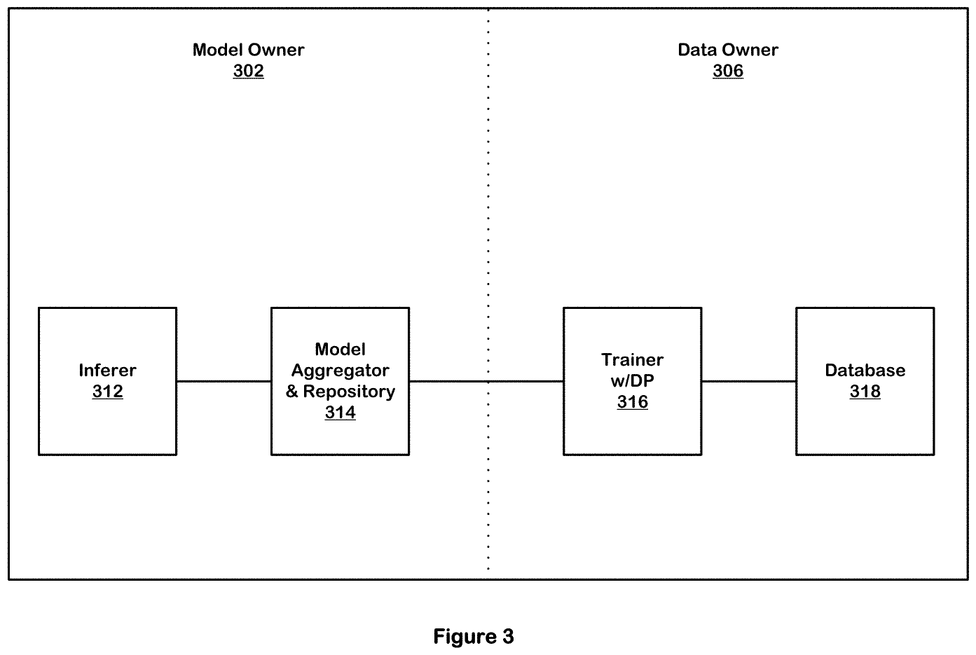

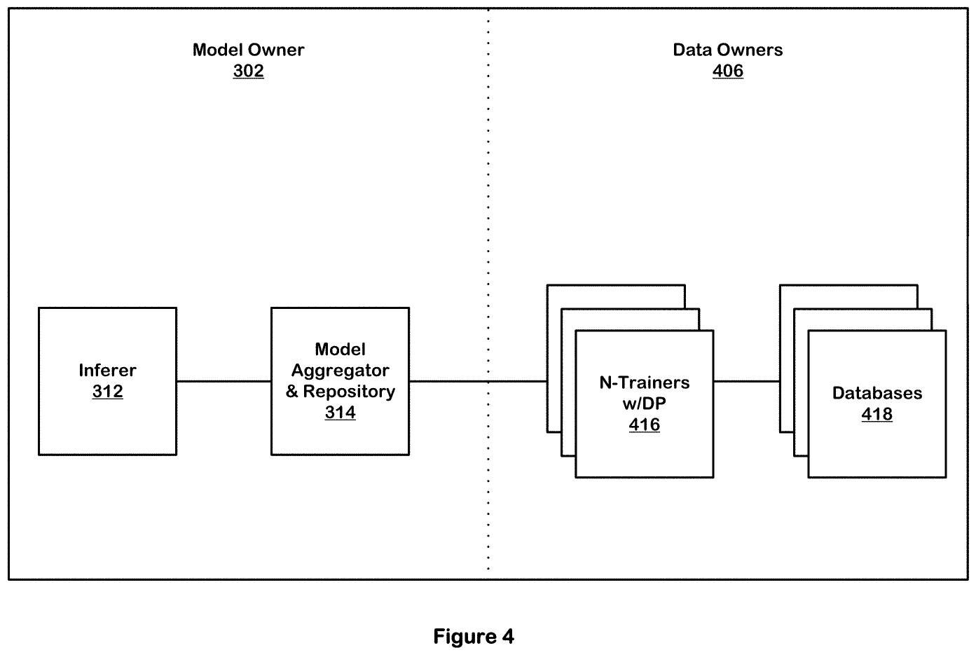

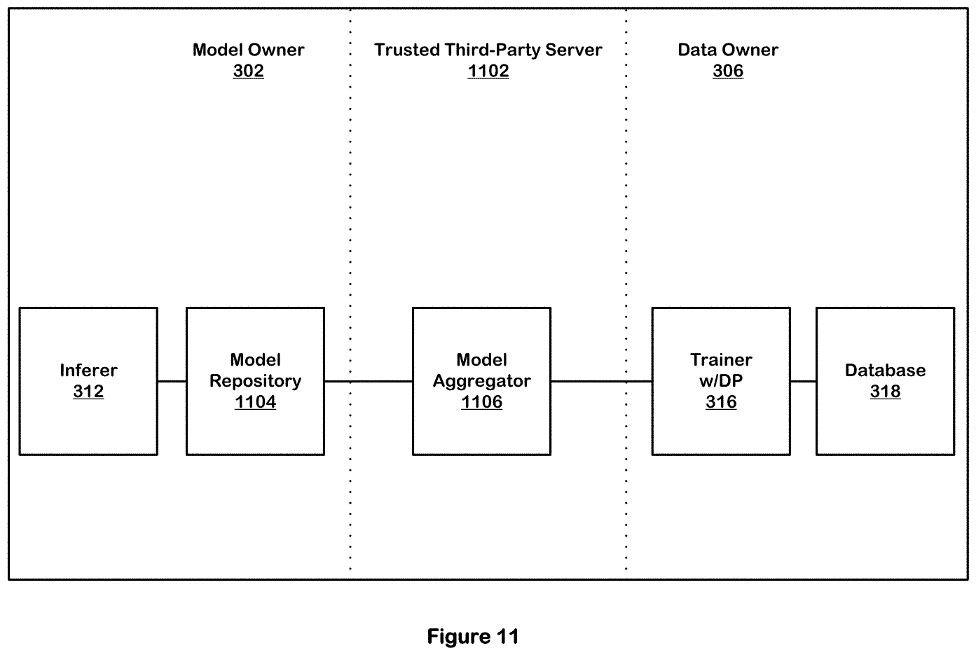

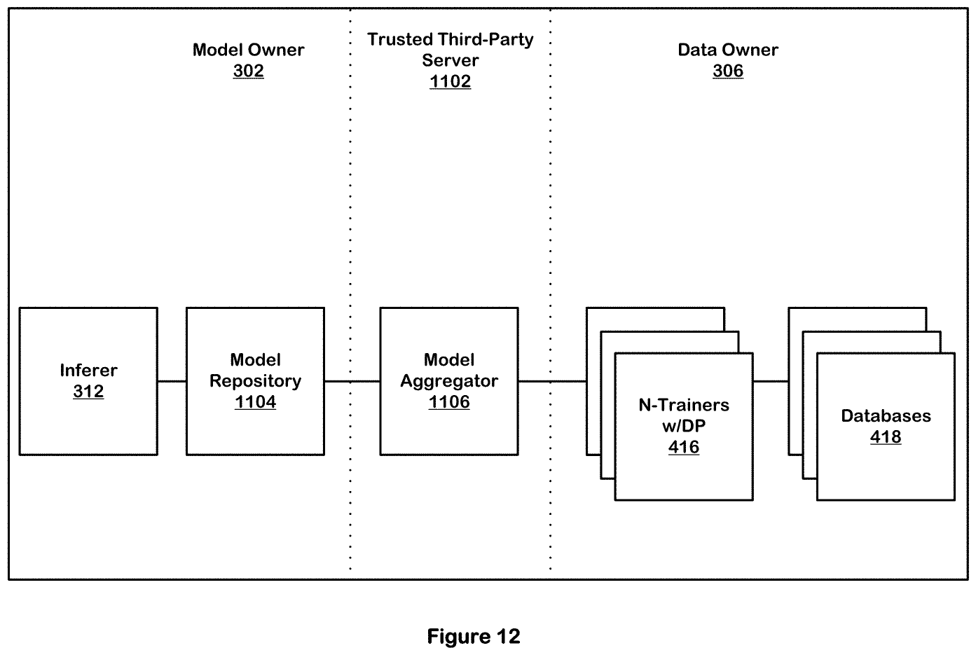

The protocol dictates how the two parties—model owner and data owner interact in a secure way. FIGS. 3 and 4 show implementations of the disclosed federal cloud learning protocol in a multi-party setup (with multiple data owners and potentially even multiple model owners). In FIG. 3, the model owner 302 comprises an inferer 312 and a model aggregator and repository 314. The data owner 306 comprises a trainer 316 and a database 318. In FIG. 4, the data owners 406 comprise a plurality of trainers 416 and a plurality of databases 418. FIGS. 11 and 12 show implementations of the disclosed federal cloud learning protocol in a multi-party setup, mediated by a trusted third-party server 1102. In FIGS. 11 and 12, the model aggregator 1106 is contained in the trusted third-party server 1102, whereas the model owner only contains the model repository 1104, without the aggregation functionality.

### Protocol Guarantees

The protocol ensures that there is minimal or no real data leakage as part of federated workflow by the model owner by enforcing the required privacy and controls.

The protocol ensures that all the privacy and security controls are with the data owner and not the model owner. This is important because it guarantees that the data owner is in charge of the levels of privacy and security protection is acceptable during training.

The protocol allows the model owner to specify the hyperparameters of the training (except security and privacy settings) in order to train a successful model.

### Protocol Steps

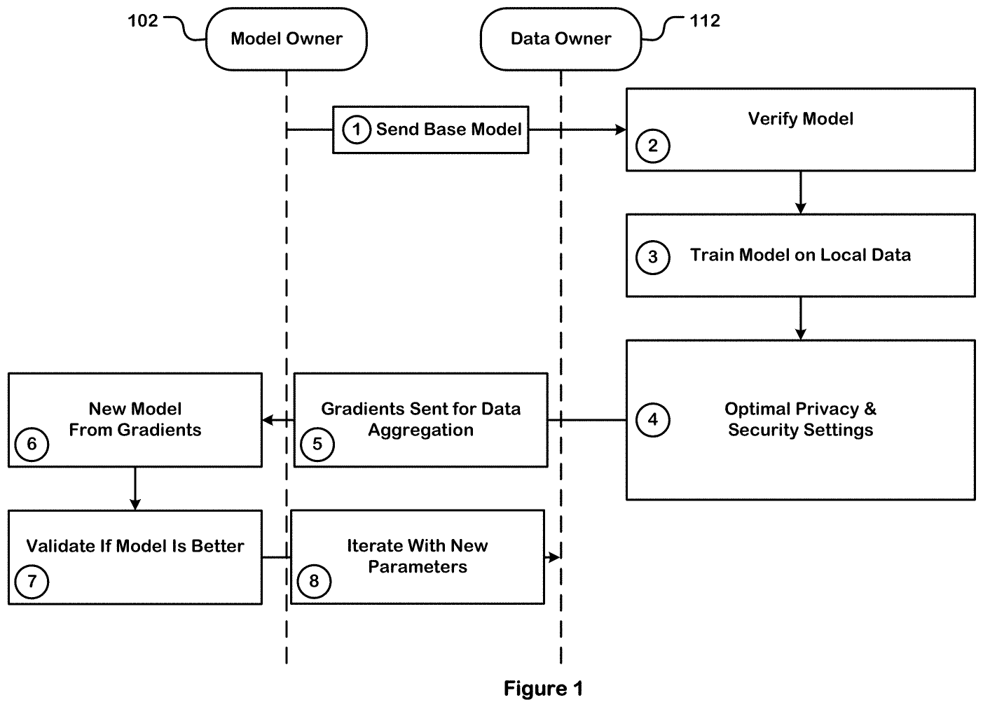

FIG. 1 illustrates one implementation of the disclosed federal cloud learning protocol. The protocol starts by the model owner 102 sending a base model to the data owner 112. The model need not be accurate, or even robust. The framework also supports an empty model as a starting point. The exchange of models takes place over a secure protocol along with validated credentials and certificates, so that both parties are verified.

Then, the data owner 112 validates and verifies the model (automatically via the federated cloud learning runtime) which guarantees that it is verified model. The admin of the data owner 112 can also manually review the model for additional security measures.

The data owner 112 configures the privacy and security settings. The applied settings will let the data owner 112, not the model owner's control what levels of data guards have to be applied on the model. This is a key step for the data owner, as it guarantees that the trained model will not potentially expose any identity of the users' data even with other publicly available datasets. See the section on Guarantees on data security and privacy section for more information.

The model is then primed to start training on secure data that is only hosted and available on the data owner cloud/data center 602. Note that the model owner has no access to this environment or the data. It is a walled garden behind the firewall of the data owner. The Federated Cloud Environment will facilitate the training of the model on data provided by the data owner.

The training step supports all standard machine learning and deep learning training operations. Once the training is complete the newly computed tensors (weights/gradients) of the model are packaged and sent to the model owner.

The Federated Cloud Environment will also automatically capture all the key information for the data owner—like audit logs, metrics, security and privacy settings. The packaged tensors (weights/gradients) are sent to the model owner.

The model owner aggregates these tensors using the Federated Cloud Learning aggregator module to produce a newly improved model.

This model is put to test to see its performance against any validation set of data that the model owner might have. This already improved model can be a new baseline model. If the model owner determines that model can be further improved, they will request for another round (epoch) of training on the data owner data (with potentially changed hyperparameters). This cycle continues until the model owner is happy with a model.

### The Federated Cloud Learning Runtime Environment

In FIG. 5, the Federated Cloud Learning Runtime Environment is a fully featured environment that consists of two key pieces. A fully scalable federated client learning runtime for the data owner 501, which can be installed on any data center 602 or cloud typically where the data is located. The runtime environment is scalable across multiple machines and works with any typical machine learning and deep learning training environments. The runtime environment also provides an Admin dashboard 512 that can be used for configuring the privacy and security settings 502, review audit logs, metrics, and all other statistical information. The runtime environment gives complete control to the admin user on of the data owner side to approve the requested training settings. A training runtime 544 trains 524 the model 514 on training data in database 552 to generate improved model 534. These are located on the client runtime and SDK 554.

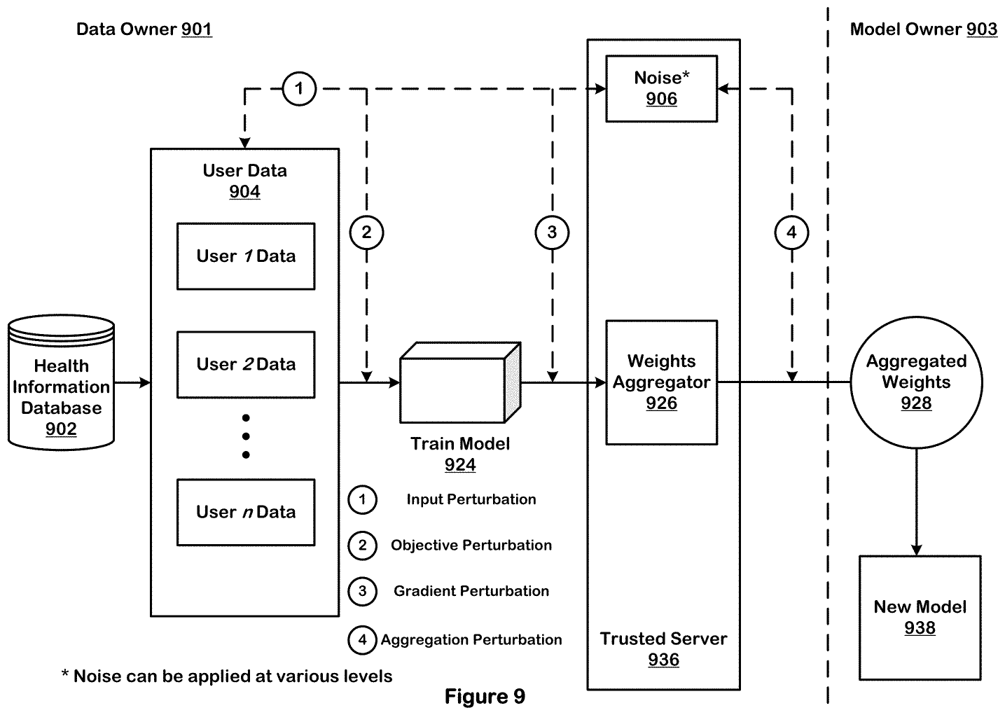

A fully scalable federated cloud learning aggregation server 546 and model repository 536 for the model owner 503 is a service that allows the model owner to aggregate weights when the training operations are completed on the data owners' side. The model repository 536 and the model aggregation server 546 are hosted on model server(s) 556. The model developer(s) 518 add the models 538 to the model repository 536. In one implementation, the fully scalable federated cloud learning aggregation server is installed on a trusted third-party server 936 (shown in FIG. 9) that performs the aggregation to provide better data privacy and security controls. A fully rich model is built from the new tensors and stored in the model repository 536 along with version information. There is an Admin panel for management of new training jobs, hyperparameter tuning, and controlling the validation of the models.

### Workflows

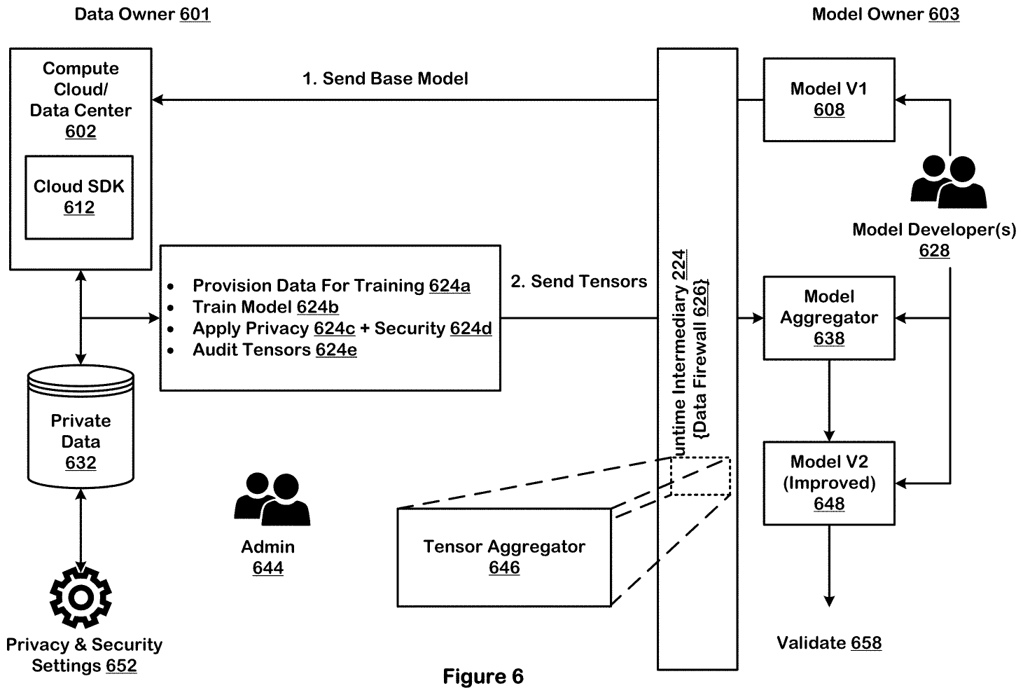

In FIG. 6, there are two key actors in the system and their respective workflows are as described below. The runtime intermediary 224 is interposed between the models (model owner) and the training datasets (data owner), and includes a data firewall 626, in some implementations.

1. From the model owner side 603:
a. A model developer(s) or a data scientists) 628, or even an admin decides to implement a model in a standard way (for example using Jupyter notebook)
b. The trained model (optional) is considered a version 1 608 and is recorded in a repository.
c. This model is then shipped (via REST APIs) to the model owner's environment.
   2. From the data owner side 601:
a. The training datasets are hosted in a compute cloud/data center 602, which includes a cloud SDK 612.
b. The admin or an infrastructure/security personnel validates and approves the model sent by the model owner 603, and then configures the necessary privacy and security settings 652 via the admin dashboard.
c. The model is then trained on private data 632 made available in the environment by configuring the data paths (all via the admin panel). The training includes provisioning data for training 624a, training the model 624b, applying privacy 624c and security 624d, and auditing tensors 624e.
d. Once the model is trained, the learned parameters are shipped back to the model owner 603, where it is aggregated to enrich the original model. In one implementation, a model aggregator or tensor aggregator (638 or 646) is used for gradient aggregation. The model aggregator can be located at the runtime intermediary 224, outside it.
e. The trained, improved model (version V2) 648 is validated 658.
f. The data owner 601 repeats the process until the requisite level of accuracy of the model is reached.

### Federated Cloud Learning Modules

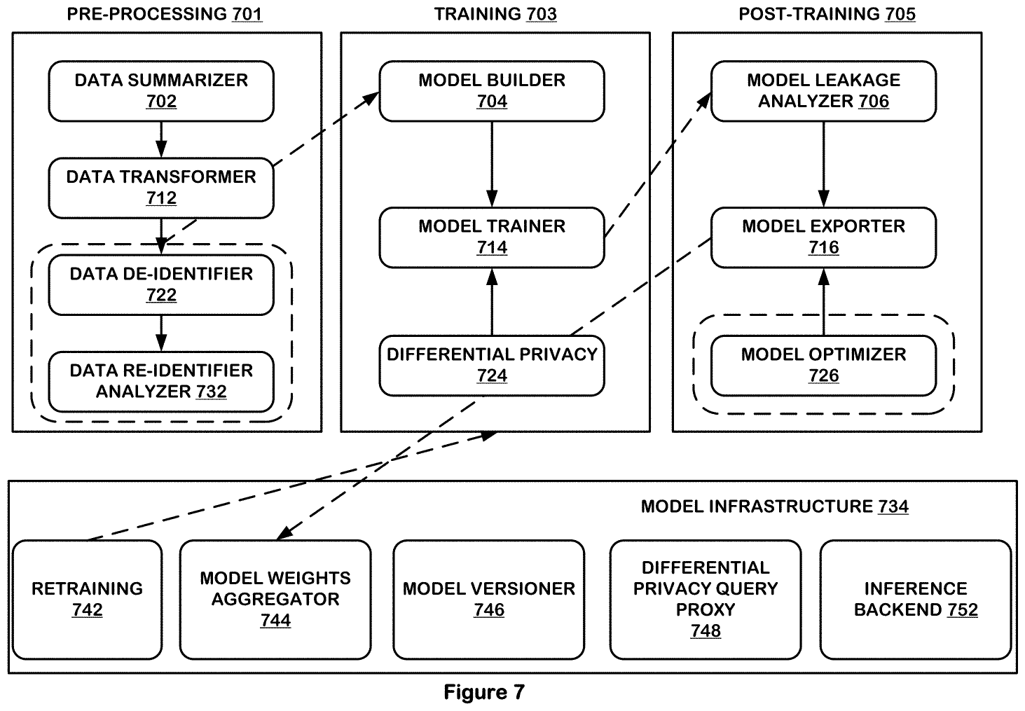

The above describes core Federated Cloud Learning infrastructure. However, we believe that many TXE participants will require auxiliary services to meet their needs, for example pre-training services for data summarizing and post-training services of model leakage analysis. Accordingly, we have developed TXE as a product to include further modules to cover those needs. This structure is presented in FIG. 7. The pre-processing part 701 includes a data summarizer 702, a data transfer 712, a data de-identifier 722, and a data re-identifier analyzer 732. The training part 703 comprises a model builder 704, a model trainer 714, and a differential privacy implementer 724. The post-training 705 comprises a model leakage analyzer 706, a model exporter 716, and a model optimizer 726. Model infrastructure 734 comprises a retraining module 742, a model weights aggregator 744, a model versioner 746, a differential privacy query proxy 748, and an inference backend module 752.

### Guarantees on Data Security and Privacy

For any machine learning technique, including Federated Learning, it is important to prevent situations permitting the training data to be estimated with varying degrees of accuracy (“model inversion”), or recovering information about whether or not a particular individual was in the training set (“membership inference”).

In a consumer federated learning setup, the data is distributed on edge devices with many users. However, in Federated Cloud Learning the data is mostly centralized at the data owner's side. This means that the data owners can provide greater guarantees to keep the identity of individuals private.

Key techniques enabling security and privacy in the context of federated learning are:
1. Differential Privacy: sampling users and adding noise to user data, so that the model masks any individuals' contribution. The noise can be estimated as well for the aggregated data.
2. Multi-Party Computation: allows for several parties to jointly train a machine learning model while preventing anyone to reconstruct the true model parameters.
3. Homomorphic Encryption: allows an owner to encrypt their model so that untrusted third parties can train or use the model without being able to steal it.

It is important to frame the problem of privacy and security in two ways when performing Federated Cloud Learning. A newly trained/improved model on data from the data owner does not leak the identities from the data. For example, if a model is being trained on medical records using federated cloud learning, it is critical that the holder of the model cannot reverse identities of the users whose data was used for training for (even though no personally identifiable information was included during training). The challenge here is providing this guarantee even when the holder of the model tries to use any publicly available dataset or knowledge about the users (for example, Facebook or Twitter data). The model does not decompose to the data completely, and that only overall statistics that can be computed from the model.

Essentially what this means is that after the analysis of a federated cloud learned model, the analyzer does not know anything about the people in the dataset. They remain “unobserved”.

A more formal definition is as follows. A randomized mechanism M: D→R satisfies (ε, δ)—differential privacy if for any two adjacent datasets X, X′ E D and for any measurable subset of outputs Y⊆R it holds that Pr [M(X)∈Y]<e^{ε} Pr [M(X′)∈Y]+δ. Refer to https://en.wikipedia.org/wiki/Differentialprivacy#% CE % B5-differentially_private_mechanisms, which is incorporated here by reference for all purposes.

The interpretation of adjacent datasets above determines the unit of information that is protected by the algorithm: a differentially private mechanism guarantees that two datasets differing only by the addition or removal of a single unit produce outputs that are nearly indistinguishable.

Differentially private systems are assessed by a single value, represented by the Greek letter epsilon (ε). ε is a measure of how private, and how noisy, a data release is. Higher values of ε indicate more accurate, less private answers; low ε systems give highly random answers that do not let would-be attackers learn much at all. One of differential privacy's great successes is that it reduces the essential trade-off in privacy-preserving data analysis—accuracy vs. privacy—to a single number.

Differential privacy promises to protect individuals from any additional harm that they might face due to their data being in the private database x that they would not have faced had their data not been part of x.

### Plausible Deniability

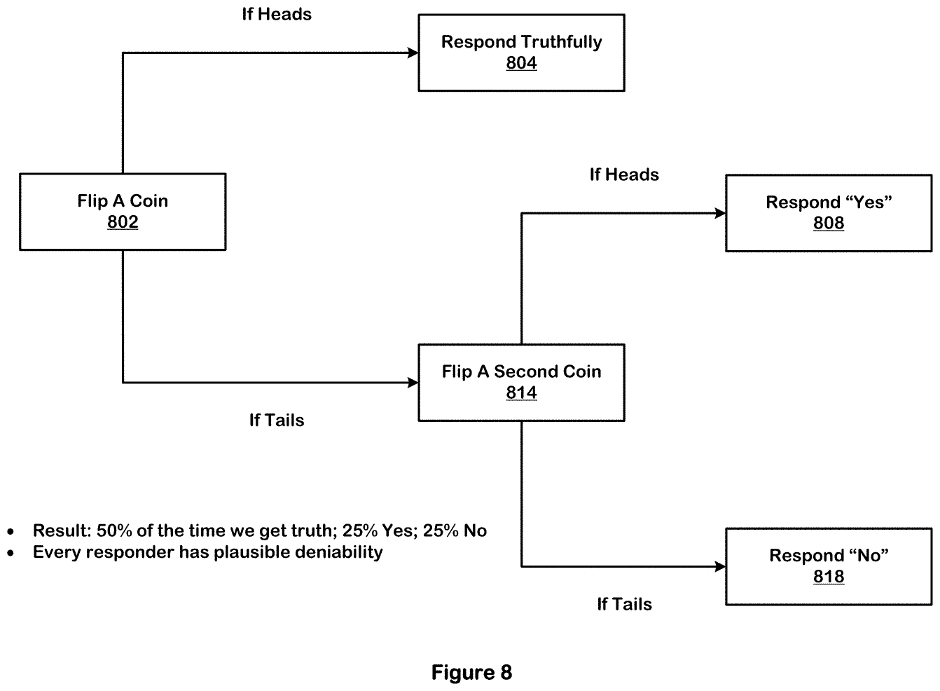

Differential privacy provides privacy by process; in particular, it introduces randomness. Here the privacy comes from plausible deniability of any outcome. By introducing random events (like a coin toss) when training on individual user's data, any subsequent attack on a trained model cannot be used to triangulate the identity of the individual with a high level of certainty. Taking the coin toss example in FIG. 8, when the coin is flipped 802, if the outcome if Heads, then the response is to respond truthfully 804. If the outcome is Tails, then another coin flip 814 is executed. If the output of the second coning flip is Heads, then the response is to respond with a “YES” 808, and if the output is Tails, then the response is to respond with a “NO” 818.

This is extremely important because we can now make guarantees that learning a company's data does not reveal who the real person is, irrespective of any other public data source available on any individual. This can truly protect privacy of individuals in the data set.

FIG. 9 has a data owner side 901 is training data 902 (e.g., health information database) and user data 904. The models are trained 902 on the user data 904 generated from the training data 902. In FIG. 9, by introducing noise 906 (at various levels) during training it will be difficult to reverse precisely if a particular dataset/user record contains the specific information. The noise is usually a Laplacian noise and can be applied at multiple points during the training:
1. On each individual user's record—this is input perturbation.
2. On training on the individual user's record—this is objective perturbation.
3. On computed gradients output—this is gradient perturbation.
4. On the aggregated model weights—this is aggregation perturbation done by a weights aggregator 926, and executed by the trusted server 936. The aggregated weights 928 are applied on the model coefficients on the model owner side 903 to generate the new model 938.

The Federated Cloud Learning admin panel makes these choices easy for the data owner.

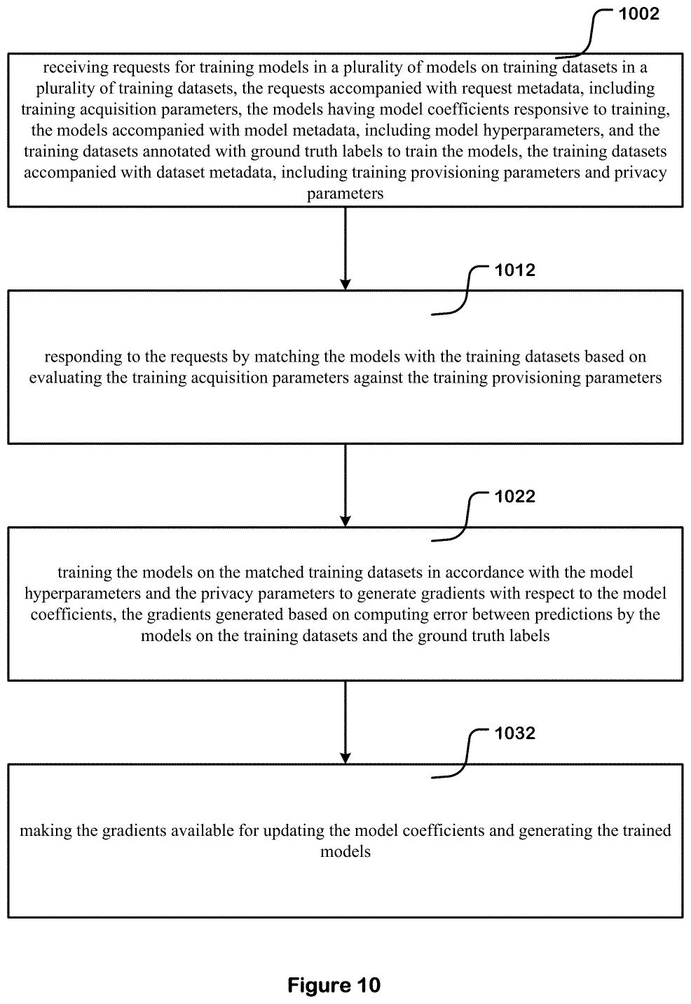

A computer-implemented method of federated training is described in FIG. 10. The method includes, at action 1002, receiving requests for training models in a plurality of models on training datasets in a plurality of training datasets, the requests accompanied with request metadata, including training acquisition parameters, the models having model coefficients responsive to training, the models accompanied with model metadata, including model hyperparameters, and the training datasets annotated with ground truth labels to train the models, the training datasets accompanied with dataset metadata, including training provisioning parameters and privacy parameters; at action 1012, responding to the requests by matching the models with the training datasets based on evaluating the training acquisition parameters against the training provisioning parameters; at action 1022, training the models on the matched training datasets in accordance with the model hyperparameters and the privacy parameters to generate gradients with respect to the model coefficients, the gradients generated based on computing error between predictions by the models on the training datasets and the ground truth labels; and at action 1032, making the gradients available for updating the model coefficients and generating the trained models.

### Use Cases for Federal Cloud Learning System and Method (“FCL”)

### Synthetic Control Arm for RCTs

Model owner Pharmaceutical company testing a new drug
Data owner Health insurance company(s)
Transaction Description In a typical randomized control trial there is a control arm which would most likely be administering a placebo instead of the actual drug. The shortcomings of using a placebo are well known—ethical considerations, and ineffective baselines.
   With FCL, it is possible to use data from a health insurer to build an imputed model that can generate a synthetic control arm with same or similar drug. The synthetic control can be performed well before the study design to understand the covariants and other parameters of the study required to make the clinical trial successful.
   The generated model can be an approximation of the placebo, giving a higher confidence on the actual trial.
Likely data types involved Claims, prescription, and diagnosis data

### Improving Diagnosis for Rare or Misdiagnosed Diseases

Model owner Pharmaceutical company aiming to increase sales of a drug for a certain rare disease
Data owner Health insurance company(s), hospital(s)
Transaction Description Some rare diseases may have a drug available for them, however they remain underdiagnosed because a highly invasive and/or expensive test is required (for example, certain types of asthma, cardiomyopathy, rickets). Non-invasive approaches can also be used but their sensitivity/specificity needs improvement.
   With FCL, it is possible to use data from health insurers and/or hospitals to build a model that would help identify which patients are more likely to have a rare variety of a disease and thus better recommend to doctors to assign the test to those patients. The model may also be able to identify a combination of multiple non-invasive approaches to further improve accuracy. For example, this can be done using a combination of blood biomarkers and non-invasive imaging. This should help increase the diagnosis levels and thus result in higher drug sales for a pharma company.
Likely data types involved Claims, prescription, medical records, imaging reports and diagnosis data

### Improvement in Drug Adherence

Model owner Pharmaceutical company aiming to increase sales of a drug Data owner Health insurance company(s), other pharma company(s)
Transaction Pharma Description companies have historically been focused on identifying factors contributing to medication nonadherence with the goal of developing strategies to improve adherence rates.
   Factors impacting adherence can be classified into 1) drug characteristics (dosing, side effects) or 2) patient (baseline) characteristics (age, socioeconomic status, diagnosis, existing medications).
   With FCL, it is possible to use data from health insurers to glean insights on which key patient characteristics are important for adherence. In addition, if also cooperating with other pharma companies, they can share their models on which aspects of a drug profile can impact real life usage.
   The result of this would be a significantly improved model on drug adherence, which can be used to help refine the marketing message for the drug by better targeting specific regions, socioeconomic groups or lifestyles and thus improve drug adherence rates.
Likely data types involved Claims, medical records, prescription, and diagnosis data

### Monetization of Failed Drugs

Model owner Biotech company, scientific community
Data owner Pharmaceutical company wishing to monetize its failed drugs or collaborate on drug research
Transaction Pharma Description companies usually possess a large amount of data on drugs that failed at various stages of discovery.
   Biotech companies are very interested in this data, as in some cases with further analysis a successful drug can be discovered, yet currently the majority of the data is unavailable for further analysis either through the sheer amount, privacy and competitive concerns.
   With FCL, biotech companies can share and test their hypotheses for drug discovery with a broader dataset of a pharma company without the need for pharma company to actually share the raw data. This could also work in a collaborative setting, when two or more pharma companies can share and test their hypotheses for drug discovery, taking advantage of their respective partner's data.
Likely data types involved Raw data on new drug research generated from target identification to clinical trials

### Predicting Treatment/Drug/Clinical Trial Success for Investment Purposes

Model owner Investment company considering new biotech investments
Data owner Health insurance company(s)
Transaction Description When considering a new biotech investment, investment companies may want to build a predictive model on market traction of a specific drug or treatment that this company makes, as well as practical effectiveness of a particular drug as a predictor of the success of follow-on research. This is even more important for less diversified biotech companies that investment companies target.
   With FCL, it is possible to use data from a health insurer to build an imputed model that can produce insights on how this drug or treatment can perform in the market.
   If the cost of building a model is low enough and the capital at risk large enough, investment companies may even pay for a simplified or similar version of the research into drug effectiveness or outcomes that the pharma company may do, with the intent to have a good predictive model before the market.
Likely data types involved Prescription and medical claims data

### Identifying Investments (Private Equity or Venture Fund)

Model owner Private equity or venture fund wishing to improve its model for identifying new investments
Data owner Investment and/or commercial bank(s)
Transaction Description Private equity and venture funds have started to build models to better predict the success of their investments. Typically, they would build a model based on their investments data, trying to identify factors that contribute to the success of an investment.
   With FCL, they can then verify their models on lending data provided by investment and/or commercial banks, which would help for example, identify investments as either high or low growth, and identify potential targets heading into distress early on and front-run a formal sale process
Likely data types involved Corporate lending data

### Improving Trading Algorithms (Hedge Fund)

Model owner Hedge fund wishing to improve its trading algorithm
Data owner Government(s), investment bank(s)
Transaction Description Hedge funds and other public market investors develop complex mathematical models to try to predict investment opportunities. Data sources in those models include credit card spending, online and foot traffic, cell-phone-geolocation, securities trading data, among others.
   With FCL, they can enhance their models on various types of currently rarely available/siloed data without receiving the raw data itself, for example exposome data from satellites to predict retail sales (and thus retail stocks performance), insurance claims levels from fires and floods (and thus insurance stocks performance), and detailed securities pricing data from investment banks' proprietary databases.
Likely data types involved Various types of alternative data (for example, exposome data), securities pricing data

### Recommending Asset Allocation

Model owner Wealth management unit within an investment bank
Data owner Investment bank
Transaction Description Wealth managers employ various techniques to recommend asset allocation for their clients.
   With FCL, they can use vast amounts of data that investment bank accumulates (with data remaining in its respective locations, preserving privacy of respective departments) as well as data on their respective clients, to build models that are highly specific to each respective client.
   This not only would help build robust models for asset allocation but will also make the asset allocation tailored to take individual client's profile into account.
Likely data types involved Securities pricing data, various client-related data (spending habits, investment horizon)

### Technical Improvements

Currently, data owners typically sell or hand over the data to parties that are interested to train their models on that data. The individuals in that data set would potentially be easily identifiable, thus compromising their privacy and breaching regulations, such as GDPR and HIPAA. The Federated Cloud Learning allows the data owner to keep the data private in its location and instead allow model owner to train a model in data owner's own or privately leased datacenter—the data never leaves their controlled environment. In an extreme case, training may occur on a single powerful machine disconnected from the internet for maximum private data security.

To ensure maximum privacy and security of the data, while enabling machine learning, the disclosed solution:
Keeps all data in the custody of the original data owner.
Uses a model is trained on the data and sent back to the model owner.
Utilizes privacy-preserving machine learning tools, such as TensorFlow Differential Privacy.
Before the model is trained, we quantize, map-to-buckets, drop or randomize features so that each particular feature value is present in at least N samples. Same may be applied to lacking features that are present in less than N samples.
For better privacy guarantees, we give the data owner control over training process, tuning of differential tuning privacy parameters, customizable pre-training data transformations per feature.
We further support federated aggregation of models trained by multiple data owners in a similar manner as described above.

Accordingly, Federated Cloud Learning permits learning to be done on multiple data sets, keeping those data sets in their respective locations without any need to perform any dataset exchange, and ensures the privacy and security of the datasets and their derivatives.

### Computer System

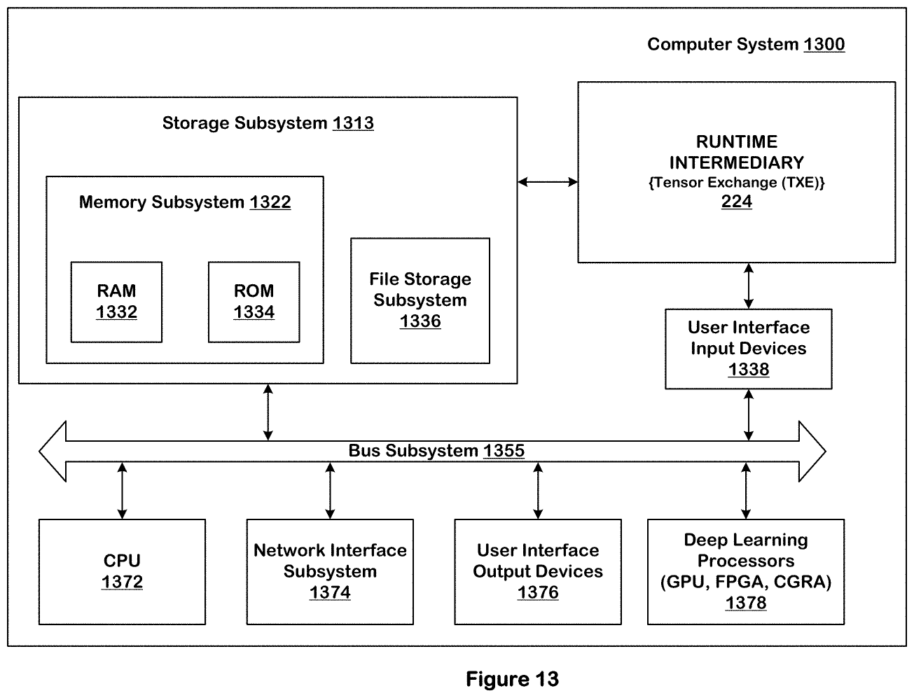

FIG. 13 is a computer system 1300 that can be used to implement the technology disclosed herein. Computer system 1300 includes at least one central processing unit (CPU) 1372 that communicates with a number of peripheral devices via bus subsystem 1355. These peripheral devices can include a storage subsystem 1313 including, for example, memory devices and a file storage subsystem 1336, user interface input devices 1338, user interface output devices 1376, and a network interface subsystem 1374. The input and output devices allow user interaction with computer system 1300. Network interface subsystem 1374 provides an interface to outside networks, including an interface to corresponding interface devices in other computer systems.

In one implementation, the runtime intermediary 224 is communicably linked to the storage subsystem 1313 and the user interface input devices 1338.

User interface input devices 1338 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 1300.

User interface output devices 1376 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 1300 to the user or to another machine or computer system.

Storage subsystem 1313 stores programming and data constructs that provide the functionality of some or all of the modules and methods described herein. These software modules are generally executed by deep learning processors 1378.

Deep learning processors 1378 can be graphics processing units (GPUs), field-programmable gate arrays (FPGAs), application-specific integrated circuits (ASICs), and/or coarse-grained reconfigurable architectures (CGRAs). Deep learning processors 1378 can be hosted by a deep learning cloud platform such as Google Cloud Platform™, Xilinx™, and Cirrascale™. Examples of deep learning processors 1378 include Google's Tensor Processing Unit (TPU)™, rackmount solutions like GX4 Rackmount Series™, GX13 Rackmount Series™, NVIDIA DGX-1™, Microsoft′ Stratix V FPGA™, Graphcore's Intelligent Processor Unit (IPU)™, Qualcomm's Zeroth Platform™ with Snapdragon Processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, Lambda GPU Server with Testa V100s™, and others.

Memory subsystem 1322 used in the storage subsystem 1313 can include a number of memories including a main random access memory (RAM) 1332 for storage of instructions and data during program execution and a read only memory (ROM) 1334 in which fixed instructions are stored. A file storage subsystem 1336 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 1336 in the storage subsystem 1313, or in other machines accessible by the processor.

Bus subsystem 1355 provides a mechanism for letting the various components and subsystems of computer system 1300 communicate with each other as intended. Although bus subsystem 1355 is shown schematically as a single bus, alternative implementations of the bus subsystem can use multiple busses.

Computer system 1300 itself can be of varying types including a personal computer, a portable computer, a workstation, a computer terminal, a network computer, a television, a mainframe, a server farm, a widely-distributed set of loosely networked computers, or any other data processing system or user device. Due to the ever changing nature of computers and networks, the description of computer system 1300 depicted in FIG. 13 is intended only as a specific example for purposes of illustrating the preferred implementations of the present invention. Many other configurations of computer system 1300 are possible having more or less components than the computer system depicted in FIG. 13.

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

What is claimed is:

1. A federated training system, comprising:
a plurality of models, models in the plurality of models having model coefficients responsive to training, and the models accompanied with model metadata, including model hyperparameters;
a plurality of training datasets, training datasets in the plurality of training datasets annotated with ground truth labels to train the models, and the training datasets accompanied with dataset metadata, including training provisioning parameters and privacy parameters; and
a runtime intermediary interposed between the models and the training datasets, and configured to
receive requests for training the models on the training datasets, the requests accompanied with request metadata, including training acquisition parameters;
respond to the requests by matching the models with the training datasets based on evaluating the training acquisition parameters against the training provisioning parameters;
train the models on the matched training datasets in accordance with the model hyperparameters and the privacy parameters to generate gradients with respect to the model coefficients, the gradients generated based on computing error between predictions by the models on the training datasets and the ground truth labels; and
make the gradients available for updating the model coefficients and generating the trained models.

2. The federated training system of claim 1, wherein the training datasets are domain-specific.

3. The federated training system of claim 1, wherein the training datasets include raw data, processed data, derived data, and market data.

4. The federated training system of claim 1, wherein the training datasets are modifiable in real-time, and the training provisioning parameters are responsive to the real-time modifications.

5. The federated training system of claim 1, wherein the dataset metadata identifies dataset schema, dataset usage examples, data set purposes, and dataset ratings.

6. The federated training system of claim 1, wherein the models are provided by model servers, and the training datasets are provided by dataset servers, wherein the runtime intermediary creates a secure tunnel to receive the models, and wherein the secure tunnel prevents the model servers from accessing the training datasets.

7. The federated training system of claim 6, wherein the runtime intermediary returns the trained models to the model servers.

8. The federated training system of claim 7, wherein the runtime intermediary trains the models on the matched training datasets using a plurality of edge devices, edge devices in the plurality of edge devices including user endpoints and servers, and configured to receive the matched training datasets, the model coefficients, the model hyperparameters, and the privacy parameters to train the models on the matched training datasets in accordance with the model hyperparameters and the privacy parameters to generate a plurality of the gradients with respect to the model coefficients.

9. The federated training system of claim 8, wherein the runtime intermediary, upon matching of the models with the training datasets, is further configured to generate a data instrument that specifies
transaction updates, including overtime changes to the training acquisition parameters and the training provisioning parameters,
memorialization of the training acquisition parameters and the training provisioning parameters that brought about the matching,
ownership details of the model servers and the dataset servers,
transactional details of the matching,
data schema of the training datasets, including input features and precision and recall measures,
terms and conditions of the training, including lifetime of the matching, training duration, and privacy specifications, and
ratings, including feedback based on prior instances of the matching and third-party opinion on the matching.

10. The federated training system of claim 9, wherein the model servers are configured to receive and aggregate the plurality of the gradients, and to update the model coefficients based on the aggregated plurality of the gradients to generate the trained models.

11. The federated training system of claim 10, wherein trusted third-party servers are configured to receive and aggregate the plurality of the gradients, to update the model coefficients based on the aggregated plurality of the gradients to generate the trained models, and to send the trained models to the model servers.

12. The federated training system of claim 11, wherein the trusted third-party servers apply a plurality of privacy enhancers on the gradients prior to making the gradients available to the model servers.

13. The federated training system of claim 10, wherein the model servers are configured to test the trained models on validation sets, and to request the runtime intermediary to further train the trained models based on results of the test.

14. The federated training system of claim 13, wherein the request for further training specifies a training duration, and is accompanied with updated model hyperparameters.

15. The federated training system of claim 1, wherein the runtime intermediary provides a dashboard for configuration of the privacy parameters.

16. The federated training system of claim 1, wherein the runtime intermediary applies a plurality of privacy enhancers on the gradients prior to making the gradients available to the model servers.

17. The federated training system of claim 16, wherein privacy enhancers in the plurality of privacy enhancers include differential privacy addition, multi-party computation, and homomorphic encryption.

18. A computer-implemented method of federated training, including:
receiving requests for training models in a plurality of models on training datasets in a plurality of training datasets, the requests accompanied with request metadata, including training acquisition parameters, the models having model coefficients responsive to training, the models accompanied with model metadata, including model hyperparameters, and the training datasets annotated with ground truth labels to train the models, the training datasets accompanied with dataset metadata, including training provisioning parameters and privacy parameters;
responding to the requests by matching the models with the training datasets based on evaluating the training acquisition parameters against the training provisioning parameters;
training the models on the matched training datasets in accordance with the model hyperparameters and the privacy parameters to generate gradients with respect to the model coefficients, the gradients generated based on computing error between predictions by the models on the training datasets and the ground truth labels; and
making the gradients available for updating the model coefficients and generating the trained models.

19. The computer-implemented method of claim 18, further including generating a data instrument that specifies transaction updates, including overtime changes to the training acquisition parameters and the training provisioning parameters,
memorialization of the training acquisition parameters and the training provisioning parameters that brought about the matching,
ownership details of model servers that provide the models and dataset servers that provide the training datasets,
transactional details of the matching,
data schema of the training datasets, including input features and precision and recall measures,
terms and conditions of the training, including lifetime of the matching, training duration, and privacy specifications, and
ratings, including feedback based on prior instances of the matching and third-party opinion on the matching.

20. A non-transitory computer readable storage medium impressed with computer program instructions for federated training, the instructions, when executed on a processor, implement a method comprising:
receiving requests for training models in a plurality of models on training datasets in a plurality of training datasets, the requests accompanied with request metadata, including training acquisition parameters, the models having model coefficients responsive to training, the models accompanied with model metadata, including model hyperparameters, and the training datasets annotated with ground truth labels to train the models, the training datasets accompanied with dataset metadata, including training provisioning parameters and privacy parameters;
responding to the requests by matching the models with the training datasets based on evaluating the training acquisition parameters against the training provisioning parameters;
training the models on the matched training datasets in accordance with the model hyperparameters and the privacy parameters to generate gradients with respect to the model coefficients, the gradients generated based on computing error between predictions by the models on the training datasets and the ground truth labels; and
making the gradients available for updating the model coefficients and generating the trained models.
